(19) United States
(12) Patent Application Publication
(10) Pub. No.: US 2005/0176368 A1
(43) Pub. Date: Aug. 11, 2005

(54) Distributed adaptive repeater system

(75) Inventors: Shane Young, Nepean (CA); Mike Roper, Ottawa (CA); Jie Zhang, Kanata (CA); Steve Allen, Ottawa (CA); Paul Simpson, Lanark (CA); Colin Kellett, Ramsbury (GB)

Correspondence Address: PEARNE & GORDON LLP, 1801 EAST 9TH STREET, SUITE 1200, CLEVELAND, OH, 44114-3108, US

(73) Assignee: SPOTWAVE WIRELESS INC., Ottawa (CA)

(21) Appl. No.: 11/065,861

(22) Filed: Feb. 25, 2005

Related U.S. Application Data
(63) Continuation of application No. PCT/CA04/00336, filed on Jun. 5, 2004.

(30) Foreign Application Priority Data
Mar. 7, 2003 (CA) 2,421,341

(51) Int. Cl. H04B 7/15

(52) U.S. Cl. 455/11.1

(57) ABSTRACT

A distributed adaptive repeater system includes a donor unit, two or more coverage units (CUs), and an intelligent hub. The donor unit operates to maintain bidirectional wireless communication with a base station of a wireless communications network. Each coverage unit maintains bidirectional wireless communication with transceivers located within a respective coverage area, and is further adapted to independently control a signal path gain to ensure stability of a respective feedback loop to the donor unit. Finally, the intelligent hub is operatively coupled between the donor unit and the coverage units, and adapted to monitor a status of each coverage unit.

### CROSS-REFERENCE TO RELATED APPLICATIONS

This is the first application filed for the present invention.

### MICROFICHE APPENDIX

Not Applicable.

### TECHNICAL FIELD

The present application relates to wireless access networks and, in particular, to distributed adaptive repeater system.

### BACKGROUND OF THE INVENTION

On-frequency repeaters are known in the art for improving wireless services within defined regions of a wireless network, where signal levels would otherwise be too low for satisfactory quality of service. For example, within a building, or a built-up urban area, signal attenuation, shadowing by buildings and/or hills; noise generated by various radio frequency sources, and multi-path effects can seriously degrade the quality of desired RF signals. In some cases, a wireless network provider may install a repeater in order to improve service in a region lying at an edge of the coverage area serviced by a base station, thereby effectively extending the reach of the base-station.

Typically, an On-frequency repeater comprises a donor antenna which “faces” a base station and enables bi-direction RF signal traffic between the repeater and the base station; a coverage antenna which faces a wireless communications device (WCD), such as a cellular handset; and an amplifier connected between the donor and coverage antennas.

On-frequency repeaters are characterized by the fact that the input and output signals (in either the uplink or dovnlink path directions) have the same frequency. The output signal (So) radiated by the repeater will normally be a replica of the input signal (Se) received by the repeater, that has been amplified and subject to a phase-shift δ due to processing delays imposed by the repeater electronics. The repeater gain (G) provides the increase in signal level that makes the repeater useful The phase shift (δ) is due to electrical delays within the repeater. This delay is inherent to the amplification process, but is caused primarily by band-pass filters used in the repeater to prevent the unwanted amplification of signals outside the frequency band of interest. Generally this delay will be small with respect to the bandwidth of any given signal.

As is well known in the art, on-frequency repeaters suffer a limitation in that the output signal (So) can feed back to the input antenna via a so-called “leakage path”. For example, amplified downlink RF signals transmitted through the coverage antenna can feed back to the donor antenna and so appear at the input of the repeater's downlink path amplifier. The feedback signal (Sf) arriving at the input antenna appears as a phase-shifted version of the external input signal (Se). Consequently, the resulting input signal (Si) received by the repeater will be the vector sum of the external input signal Se and the feedback signal Sf. The magnitude of the input signal Si is a function of both the amplitude of the external input signal Se and the feedback signal Sf, and their relative phases. For a repeater system that employs automatic gain control, the magnitude of the output signal So, and thus the feedback signal Sf, will be held approximately constant over a wide range of input power.

However, if the system gain (G) becomes too high, so that Sf≧Se, then signal leakage between the output and input antennas will cause system oscillation. In principle, system stability can be obtained by ensuring that the antenna isolation (L) is equal to or greater than the system gain (G). However, in practice, the antenna isolation is difficult to predict, and will frequently change over time. Accordingly, conventional on-frequency repeaters are normally adjusted to provide a total system gain of about 10-15 db less than the antenna isolation, in order to provide an unconditionally stable system that precludes oscillation (even in a changing RF environment). This high (10-15 db) margin between antenna isolation and system gain is commonly achieved by limiting and sacrificing system gain, which significantly decreases the sensitivity (and thus efficiency) of the repeater.

As is well known in the art, the provision of adequate wireless services within buildings can pose particularly difficult problems. This is typically due to shielding effects of building walls; jamming due to RF emissions from equipment (such as motors, electronic devices etc.) within the building; and severe multi-path fade. Two primary methods have been proposed for addressing these difficulties: namely “leaky” cable; and multiple coverage antennas.

Leaky Cable systems utilize a network of co-axial cables for distributing RF signals throughout a predefined area. Within predefined portions of the coaxial cable, the shielding jacket is perforated, so that some of the RF energy within the cable “leaks” out, and is radiated into the region surrounding the cable. These systems tend to be expensive, and suffer high losses.

The use of multiple coverage antennas has also been proposed as an alternative to leaky cable. These systems typically utilize a single donor antenna coupled to a distribution hub, which operates to supply RF power to each of the coverage antennas. Typically, the hub also provides the system gain, and may include system monitoring and management functions. Thus the coverage antennas are substantially passive devices. Depending of the design requirements, signal traffic between the hub and the coverage antennas may be at RF, or at some predetermined IF, as desired. In the later case, the coverage antennas are not strictly passive, because they will also contain a local oscillator to facilitate signal conversion between RF and IF.

These repeaters typically utilize a single Automatic Gain Control (AGC) for the uplink path to reduce uplink gain and uplink transmit power when mobile wireless communications devices (WCDs) are in close proximity to a coverage antenna/leaky cable. Thus when a WCD in the coverage area “captures” the AGC, the transmit power of all WCDs within the coverage area of the entire distributed antenna/leaky cable array may be reduced below that required to maintain the link to the wireless base station.

In order to provide consistent coverage throughout the building interior, the various coverage antennas will normally be arranged with overlapping coverage areas. However, because, every coverage antenna necessarily radiates the same RF signal, spatial nulls are created at locations where RF signals radiated from different coverage antennas have equal amplitude and a phase difference of 180°. These spatial nulls are substantially stationary, and can severely disrupt wireless communications. An additional problem encountered with multiple coverage antennas is that some of the energy radiated by each coverage antenna (i) will appear at the donor antenna as a feedback signal Sfᵢ. Each feedback signal Sfᵢ will have a respective different phase and amplitude, and the total feedback signal Sf_{T}[=ΣSfᵢ] at the repeater input will be the vector sum of the multiple feedback signals Sfᵢ.

From the point of view of the repeater's amplifier and control circuitry, this situation is equivalent to operation of a simple repeater (that is, a repeater having a single donor antenna and a single coverage antenna) operating in a severe multipath environment. In some cases, the presence of multiple feedback signals Sfᵢ at the repeater input can defeat the antenna isolation detection and monitoring system entirely, thereby rendering the repeater inoperative. In other cases, the isolation monitoring system will be captured by the strongest feedback signal Sf_{MAX}. When this happens, the repeater gain G is controlled based on the “worst case” feedback path, with the result that the signal level and coverage area of all of the other coverage antennas may be reduced below desirable levels.

Accordingly, a system that enables cost-effective provision of reliable wireless service within severe RE environments remains highly desirable.

### SUMMARY OF THE INVENTION

An object of the present invention is to provide an method and system for providing reliable wireless service within severe RF environments.

This object is met by the features of the invention defined in the appended independent claims. Additional optional features of the invention are defined in the dependent claims.

Thus the present invention provides a distributed adaptive repeater system, which includes a donor unit, two or more coverage units (CUs), and an intelligent hub. The donor unit operates to maintain bidirectional wireless communication with a base station of a wireless communications network. Each coverage unit maintains bidirectional wireless communication with transceivers located within a respective coverage area, and is further adapted to independently control a signal path gain to ensure stability of a respective feedback loop to the donor unit. Finally, the intelligent hub is operatively coupled between the donor unit and the coverage units, and adapted to monitor a status of each coverage unit, and optionally report status to a remote monitoring system.

### BRIEF DESCRIPTION OF THE DRAWINGS

Further features and advantages of the present invention will become apparent from the following detailed description, taken in combination with the appended drawings, in which:

FIG. 1 is a block diagram schematically illustrating principle elements of an on frequency repeater in accordance with the present invention;

FIG. 2 is a block diagram schematically illustrating principle elements of a coverage unit of FIG. 1;

FIG. 3 is a block diagram schematically illustrating principle elements of a, first distribution hub usable in the embodiment of FIG. 1; and

FIG. 4 is a block diagram schematically illustrating principle elements of a second distribution hub usable in the embodiment of FIG. 1.

It will be noted that throughout the appended drawings, like features are identified by like reference numerals.

### DETAILED DESCRIPTION OF THE PREFERRED EMBODIMENT

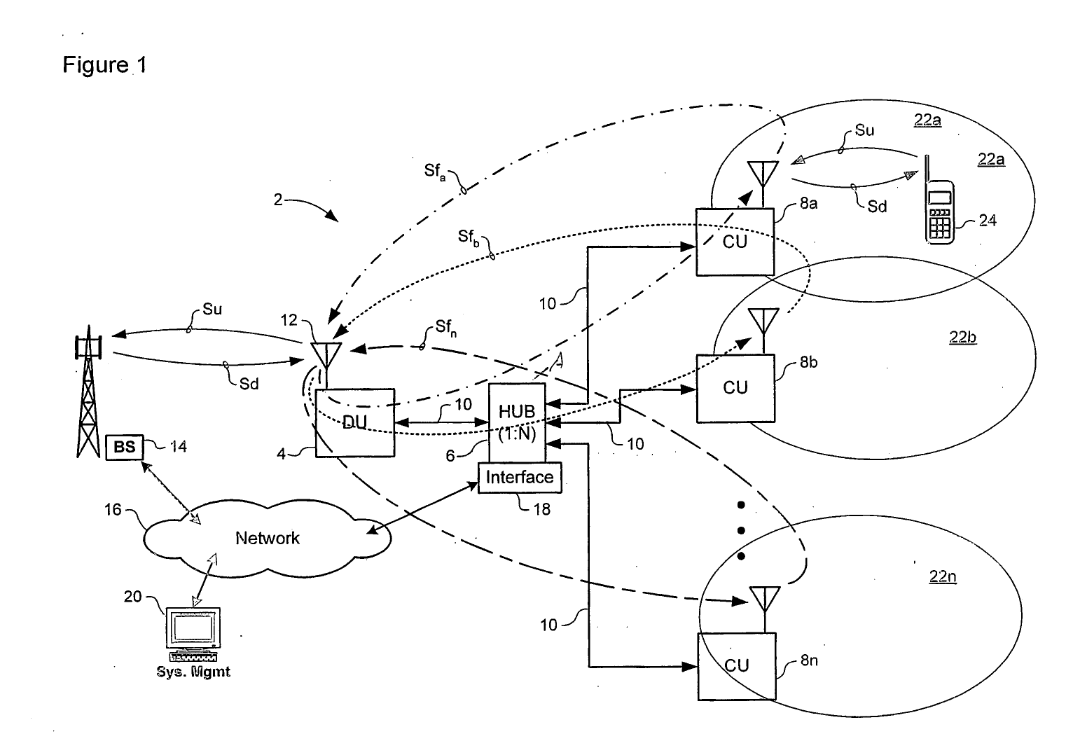

The present invention provides a cost effective system for providing reliable wireless services within a severe RF environment, such as, for example, within the interior of a building. FIG. 1 is a is a block diagram schematically illustrating principle elements of an on frequency repeater in accordance with the present invention.

As shown in FIG. 1, the repeater 2 generally comprises a donor unit (DU) 4, an intelligent hub 6, and two or more coverage units (CUs) 8. Conventional transmission lines 10, such as RG-58 or RG-6 co-axial cable, are used to convey signals between the donor unit 4, the hub 6, and each of the coverage units 8.

The donor unit comprises a donor antenna 12 integrated with a bidirectional amplifier (not shown), which provides sufficient gain to overcome losses in the cable 10 and the intelligent hub 6. This arrangement enables the use of low cost co-axial cable, thereby reducing the overall system cost, and simplifying installation. In general, the DU 4 operates to maintain a bidirectional wireless link with a base station 14 coupled to a conventional communications network 16, such as, for example, the Public Switched Telephone Network (PSTN) or Internet. Thus the DU 4 receives downlink RF signals (Sd) from the base station 14, and transmits uplink RF signals (Su) to the base station 14. In order to minimize leakage of uplink RF signals Su back to the CUs 8, and to maximize system efficiency, the donor antenna 12 is preferably provided as a high gain antenna designed to transmit and receive RF signals within a comparatively narrow beam.

In the illustrated embodiment, the base station 14 is illustrated as a conventional land-based cell site. However, it will be appreciated that the base station 14 may be provided in various forms, such as a satellite, without departing from the scope of the present invention.

As is well known in the art, the DU 4 may be coupled to each of the N coverage units 8 by means of a conventional matched 1:N RF power divider. At a minimum, the intelligent hub 6 furnishes this functionality. Preferably, however, the intelligent hub 6 also enables a wide variety of system management functionality, as will be described in greater detail below. If desired, the intelligent hub 6 may be provided with a network interface 18 (e.g. a modem) which enables the intelligent hub 6 to communicate with remote devices such as a central monitoring point 20 via the network 16. This functionality will also be described in greater detail below.

Each coverage unit (CU) 8 operates to provide wireless access within a local coverage area 22 about the CU 8. Thus, each CU 8 radiates downlink signals Sd into its coverage area 22, and receives uplink signals Su from wireless devices 24 within its coverage area 22. As may be seen in FIG. 1, adjacent coverage areas 22 may overlap. This facilitates continuity of wireless access within the area serviced by the CUs, but at the cost of creating spatial nulls within the overlapping region.

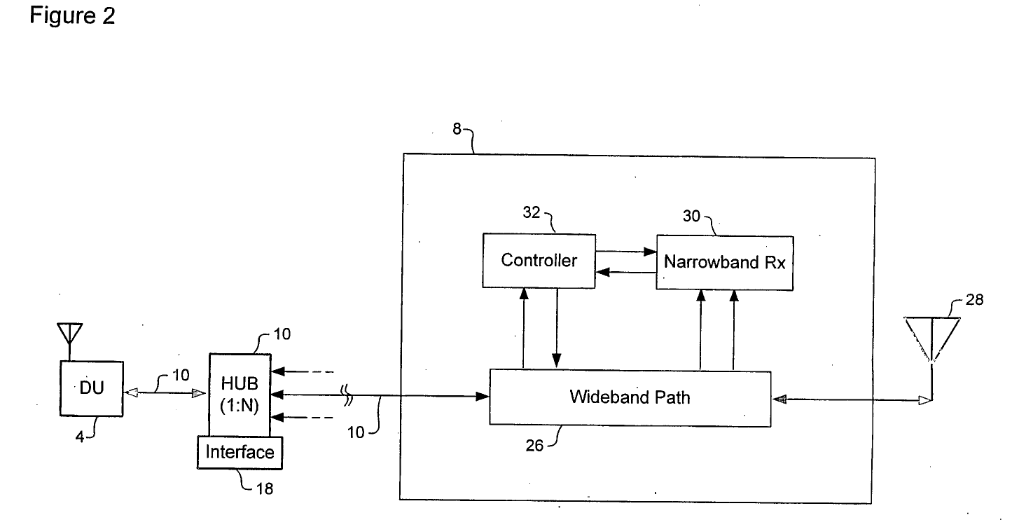

As shown in FIG. 2, each coverage unit (CU) 8 comprises a bidirectional wideband signal path 26 coupled to a coverage antenna 28; a narrow band receiver 30, and a controller 32.

In general, the bandwidth of the signal path 26 will be selected to encompass the range of frequencies that are expected to be used by the communications network within which the repeater will operate. For example, in North America publicly accessible Advanced Mobile Phone Service (AMPS) and Time Division Multiple Access (TDMA) cellular communications networks typically utilize 25 MHz wide uplink and downlink bands. Other networks, such as Global System for Mobile Communications (GSM) and Code Division Multiple Access (CDMA), utilize respective different bands, each having known bandwidth and center frequencies. In some cases, it will be desirable to make the bandwidth of the signal path 26 broad enough to encompass traffic of multiple different networks. In such cases, the signal path 26 may have a bandwidth of 60 MHz, or more, and carry any one or more of AMPS/TDMA, GSM, CDMA and other traffic types.

In order to provide a wide coverage area 22, the coverage antenna is preferably provided as either an omni-directional antenna, or as a directional antenna having a comparatively wide radiation pattern. As is known in the art, such an antenna means that feedback signals Sf will leak back to the donor antenna 12, and appear at the amplifier input. Thus a respective feedback loop is defined between each CU 8 and the DU 4, as may be seen in FIG. 1.

The controller 32 operates under control of software implementing an Adaptive Control Algorithm (ACA) to monitor signal power levels within the signal path 26, and control the gain of the signal path 26 to optimize the path gain and ERP radiated from the coverage antenna and prevent oscillation of the respective feedback loop. Thus each CU 8 of the present invention implements broadband gain control based on narrow band power levels of desired signals within the signal path 26. Compared to conventional repeater systems in general, the present invention avoids the limitation of prior art AGC amplification techniques, in which path gain is controlled based on the total power level (of all of the traffic) within the signal path 26. With reference to conventional multiple coverage antenna systems, the present invention avoids reducing the energy radiated by all coverage antennas to satisfy the “worst-case” antenna. In the present invention, each CU 8 independently monitors and actively optimizes its own performance. In effect, each CU 8 cooperates with the DU4 and the intelligent hub 6 to define a respective independent adaptive repeater and the controller 32 operates to adaptively manage the performance and stability of that repeater. In some embodiments, the controller 32 hunts for and isolates a control channel within the signal path 26 as the desired channel for controlling gain. This improves reliability by ensuring that signal path gain control is implemented using a channel that almost always carries a valid signal, even when little or no subscriber data traffic is being conveyed through the network.

Since each CU 8 includes its own uplink AGC, the present invention ensures that uplink AGC gain reduction due to an WCD in close proximity to the CU 8 will be limited to that particular CU 8, and thus will not affect the transmit power of WCDs in coverage areas 22 served by other CU's.

In order to prevent oscillation of the respective feedback loop, the methods of application's co-pending U.S. patent application Ser. No. 10/299,797, filed Nov. 20, 2002 may be used to monitor stability of the respective feedback loop. Thus, a signature signal is inserted into the signal path 26 and radiated by the coverage antenna 28, and corresponding signal components appearing in the downlink signal received from the intelligent hub 6 are detected. The signature signal is designed such that it does not interfere with subscriber traffic (e.g. it appears as a low level fade), and the corresponding signal components within received downlink signal traffic can be unambiguously discriminated from noise. Correlation between the transmitted signature signal with the detected signal components provides an indirect indication of the stability of the repeater.

In principle, the signature signal may be provided as any signal pattern that can be reliably detected within the downlink signal (Sd) received from the intelligent hub 6, without disrupting normal operation of either the repeater 2 or other transceivers of the wireless communications network. For example, the signature signal is composed as a stream of signal pulses separated by corresponding quiescent periods. Each signal pulse is defined by a pulse function Sp(t), which governs the waveform (shape), frequency and amplitude of the pulse. In principle, any pulse waveform that can be positively detected in the received downlink signal (Sd), such as, for example, square, sinusoidal, or triangular waveforms may be used.

As will be appreciated, various means may be used to add the signature signal to the signal path 26 for transmission. In principle, either amplitude or phase modulation techniques may be used, either alone or in combination, to accomplish this function. In either case, the received downlink signal (Sd) will include a signal component that corresponds with the (amplitude and/or phase) modulation appearing in the feedback signal (Sf), and this signal component can be isolated and detected by the narrowband receiver 30. The modulation power level of the signal component measured by the narrowband receiver 30 is then passed to controller 32. The controller 32 can be readily programmed to calculate a correlation between the respective power levels of the transmitted signature signal and the detected signal components within the received downlink signal (Sd). The correlation result provides a direct indication of total signal leakage between the CU 8 and the DU 4, and an indirect indication of the stability of the feedback loop. Based on this information, the controller 32 can implement various control functions such as, for example, controlling the gain of the signal path 26 to ensure unconditional stability of the feedback loop.

As mentioned above, each CU 8 independently monitors stability and operates to prevent oscillation. By providing each CU 8 with a respective unique signature signal, each CU 8 is capable of discriminating its own signature signal from those of neighboring CUs, thereby preventing collisions and interference between signature signals from other CUs 8.

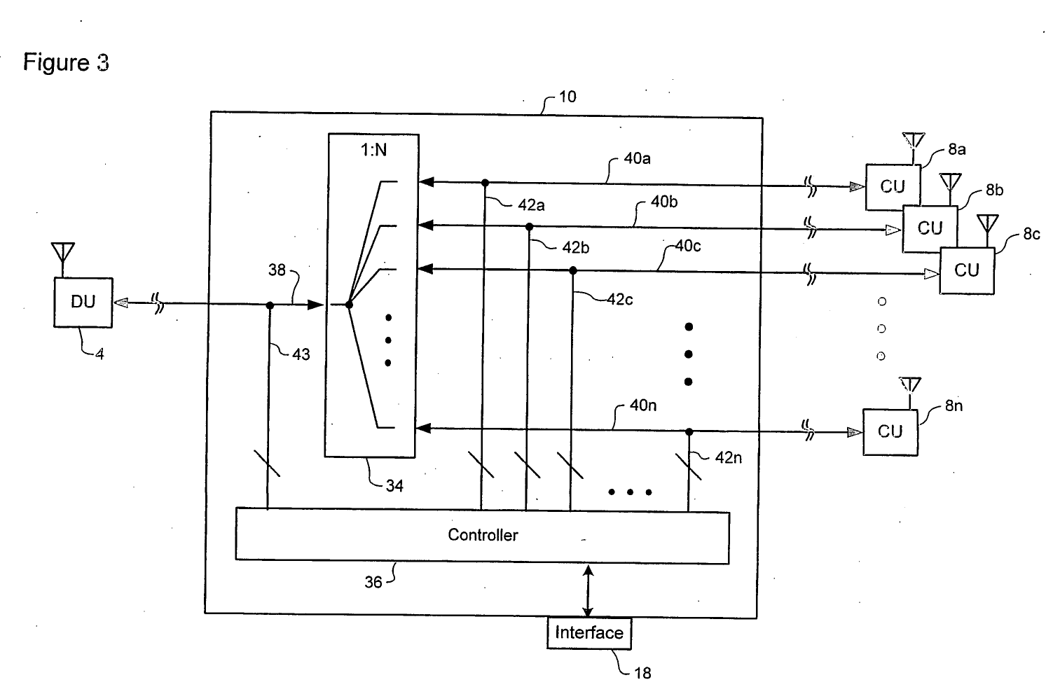

If desired, the intelligent hub 6 may be provided as a substantially passive device, or alternatively may be capable of complex monitoring and control functionality. In the embodiment of FIG. 3, the intelligent hub 6 comprises a matched 1:N power divider/combiner 34, and a controller 36 for monitoring an operational status of each CU 8 coupled to the intelligent hub 6. The controller 36 can be implemented by any suitable combination of hardware and software to implement desired distributed adaptive repeater functionality. The 1:N power divider/combiner 34 operates in a conventional manner to provided a matched coupling between an input line 38 (coupled to the donor unit 4) and each of N feed lines 40 (connected to the coverage units 8). Each feed line 40 is tapped in a known manner to provide a respective tap line 42 between the controller 36 and the feed line 40. Similarly, the input line 38 can be tapped by a respective tap line 43. The tap lines 42, 43 are coupled to the controller 36, and configured to enable any one or more of: DC voltage and/or current; AC and/or DC power; analog signaling; and digital signaling to be conveyed through the feed lines 40 to the CU's, and the input line 38 to the DU 4. With this arrangement, the controller 36 can communicate with each of the CUs 8 and the DU 4 to implement various distributed adaptive repeater functions, as will be described in greater detail below.

In a simple example, controller 32 of each CU 8 can be programmed to transmit status information to the hub controller 36. Similarly, status information from the DU 4 can be received by the hub controller 36. This status information may be a simple as a predetermined DC offset (e.g. of +3 volts) which indicates that the CU 8 is functioning. Alternatively, any of variety of system statistics and health information may be accumulated by the CU controller 32, and transmitted to the hub controller 36, e.g. as a digital signal within a predetermined control channel.

As may be appreciated, a wide range of different status information may be transmitted by each coverage unit to the distribution hub. For example, path gain; stability margin; and fault status are just three possibilities. Other possible status information will become apparent to those of ordinary skill in the art, and are considered to fall within the scope of the present invention.

Upon receipt of the CU status information, the hub controller 36 can perform various functions. For example, CU failures can be detected, and an alarm raised. Such an alarm may take the form of a warning light on the hub 6, which can be seen by a user. Alternatively, an alarm indication can be formulated by the controller 36 and transmitted through the network 16 to a central monitoring facility 20. As may be appreciated, the central monitoring facility 20 may take many forms, including, for example, a web page that can be readily accessed by users an/or service personnel via the internet. Communication between the hub controller 36 and the central monitoring facility 20 may be accomplished via the (optional) interface 18 connected to the network 16, or wirelessly via the DU 8 and base station 14. In another example, CU status information may be used by the hub controller 36 to calculate various system statistics, which can be either transmitted to the central monitoring facility 20 (as described above) or stored (e.g. in a FLASH memory—not shown) for later analysis, either by the controller 36 or maintenance personnel.

Various system statistics that may be of interest will be apparent to those of ordinary skill in the art, such as, for example, system utilization rate (i.e. the percentage of CU capacity being used); CU power demand; Signal-to-noise ratio, etc.

In addition to simply reporting fault alarms and status information, the hub controller 36 can also use data received for the CUs 8 to adaptively control the operation of the distributed repeater 2. For example, upon detection of a faulty CU 8, the hub controller 36 can operate to shut down the offending CU 8. This operation may be automated (e.g. as part of the alarm-handling function), or in response to a command received from the central monitoring facility 20, either via the interface 18 or wirelessly via the base station 14 and DU 8.

In addition to monitoring system status and responding to alarm states, the hub controller 36 can be programmed to “learn” the RF environment in which it is operating, and adapt the functionality of the distributed repeater 2 to suit that RF environment. For example, system utilization can be monitored by detecting subscriber signal traffic. This can be performed by each CU controller 32, or by the hub controller 36, or both. In either case, variations in the system utilization with time can be detected, and used to derive usage patterns. For example, in an office building, high system utilization may be experienced during week-days, and low or no system utilization at other times (e.g. on week-ends and at night time). Once this pattern is detected, the hub controller 36 can control the CUs 8 to adjust power consumption, e.g. by shutting down one or more CUs during periods when no utilization is expected. This functionality may be implemented on a per-CU basis, or globally across all of the CUs of the distributed repeater, as desired.

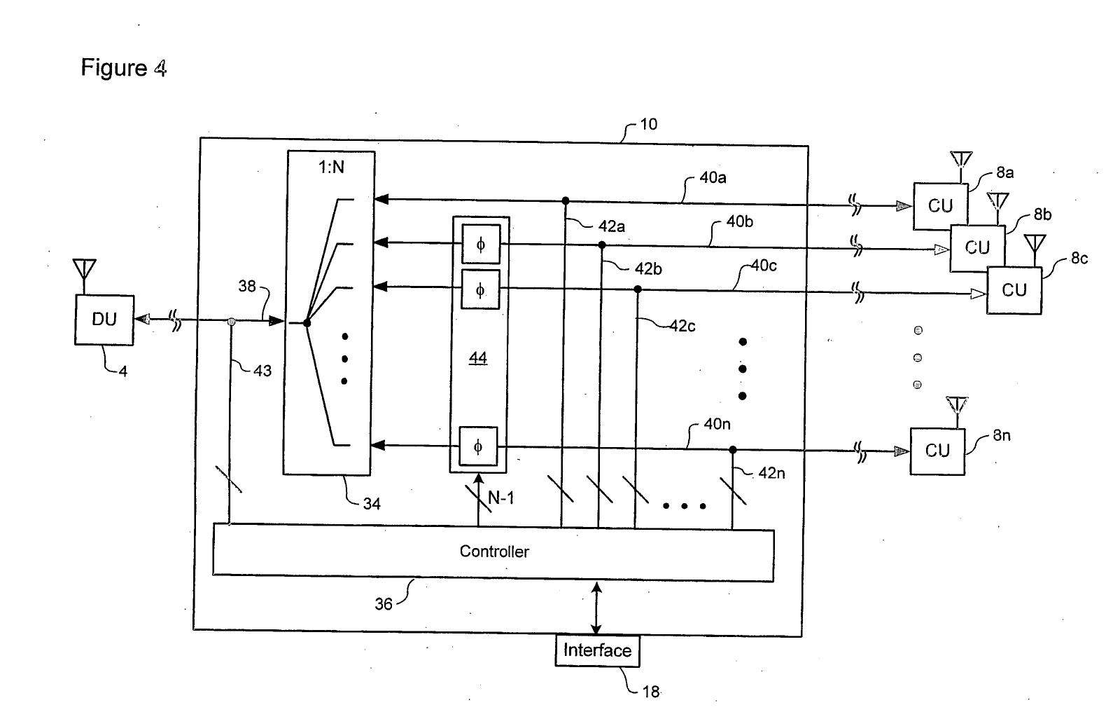

In order to prevent spatial nulls from being created from CUs 8 being located with overlapping coverage areas 22, the intelligent hub 6 of FIG. 3 can be modified by adding a phase shifter array 44. As shown in FIG. 4, the phase-shifter array 44 comprises N-1 phase shifters, each of which is controlled by the hub controller 36. Thus the hub controller 36 can dither the phase delay of each feed-line 40 (either randomly, or in accordance with a predetermined dither pattern) in order to minimize the probability of two or more uplink or downlink signals destructively adding together, either within the coverage area 22 or at the power divider 34. This facilitates continuity of wireless access within the area serviced by the CUs without creating spatial nulls within regions of coverage area overlap. If desired, this functionality call also be achieved by carrying the amplitude of signals traversing each feed-line, either in conjunction with phase dithering or in isolation.

The signature signal inserted into the signal path 26 and radiated by the coverage antenna 28 of a CU 8 can also be used as a further method for preventing spatial nulls from being created from CUs 8 with overlapping coverage areas 22. In this embodiment the unique signature signals from each involved CU 8 provides amplitude and/or phase shifts that prevent stationary spatial nulls from being generated. This facilitates continuity of wireless access within the area serviced by the CUs 8 without creating spatial nulls within the overlapping region.

The embodiment(s) of the invention described above is(are) intended to be exemplary only. The scope of the invention is therefore intended to be limited solely by the scope of the appended claims.

1. A distributed adaptive repeater comprising:
a shared donor unit for maintaining a bidirectional wireless communication link with a base station;
two or more coverage units (CUs), each CU comprising:
a respective coverage antenna for maintaining bidirectional wireless communication with transceivers located within a respective coverage area served by the CU; and
a respective CU controller for independently controlling gain of a respective signal path between the donor unit and the coverage antenna, so as to ensure stability of a respective feedback loop to the donor unit:
an intelligent hub operatively coupled between the donor unit and each of the coverage units.

2. A repeater as claimed in claim 1, wherein the intelligent hub comprises a signal splitter/combiner for splitting/combining the respective signal paths between the shared donor unit and each of the CUs.

3. A repeater as claimed in claim 2, wherein the intelligent hub further comprises a hub controller coupled to each signal path for communication with the respective CU controller of each CU.

4. A repeater as claimed in claim 3, wherein the CU controller is adapted to transmit status information indicative of an operational status of the CU to the hub controller, via the CU's respective signal path.

5. A repeater as claimed in claim 3, wherein the hub controller is adapted to accumulate statistics respecting operation of each of the CU.

6. A repeater as claimed in any one of claims 4 or 5, wherein the intelligent hub further comprises means for communicating with a central monitoring facility.

7. A repeater as claimed in claim 6 wherein the means for communicating comprises an interface between the hub controller and a communications network.

8. A repeater as claimed in claim 3, wherein the intelligent hub further comprises a respective phase shifter operatively coupled to at least one signal path and controlled by the hub controller, such that the hub controller can adjust a signal phase differential between one signal path and at least one other signal path.

9. A repeater as claimed in claim 8., wherein a respective phase shifter is provided in each of N-1 signal paths (where N is the number of signal paths).

10. A repeater as claimed in claim 9., wherein the hub controller is adapted to dither respective phase delays of each phase shifter, so as to mitigate effects of spatial nulls.
